(19) United States
(12) Patent Application Publication
(10) Pub. No.: US 2021/0100637 A1
(43) Pub. Date: Apr. 8, 2021

(54) THREE-DIMENSIONAL ORAL SURGERY TOOL AND METHODS

(71) Applicant: Jong Kwon YOON, St. Catharines (CA)

(72) Inventor: Jong Kwon YOON, St. Catharines (CA)

(21) Appl. No.: 17/062,434

(22) Filed: Oct. 2, 2020

Related U.S. Application Data
(60) Provisional application No. 62/909,692, filed on Oct. 2, 2019.

(30) Foreign Application Priority Data
Apr. 3, 2020 (CA) 3077882

(51) Int. Cl. A61C 3/025

(52) U.S. Cl. CPC A61C 3/025

(57) ABSTRACT

An instrument for performing periodontal surgery comprises a longitudinally extending handle, a blade section comprising at least one cutting edge, a connector comprising a first end coupled to the handle and a second end coupled to the blade section. The connector spaces the blade section laterally from the handle, relative to a longitudinal extent of the handle, and the cutting edge(s) define a cutting plane that is substantially parallel to the longitudinal extent of the handle. The instruments provide a three-dimensional structure that facilitates periodontal surgery.

### TECHNICAL FIELD

The present disclosure relates to instruments for periodontal surgery.

### BACKGROUND

Canadian Patent No. 2,616,140 and U.S. Pat. Nos. 8,007,278 and 8,202,092 describe a periodontal surgery instrument that generally comprises a handle, a first shank connecting to and extending from the handle, a connector section, and a blade section. The connector section has a first end and a second end, and the first end connects to the shank and the second end connects to the blade section. The blade section is approximately perpendicular to the plane formed by the handle and the connector section, and the blade section has a cutting surface that is parallel to the second end of the connector section.

The above-described instrument can be used in surgical procedures in which gum recession can be corrected without a scalpel or sutures. A small hole is made using a needle, and then the blade section of the special instrument is inserted through the hole. The handle is then rotated about its axis so that the blade section will loosen the gum tissue, which can then be repositioned over the receded portion of the tooth.

### SUMMARY

The present disclosure is directed to further improvements upon the surgical instruments publicly disclosed in Canadian Patent No. 2,616,140 and in U.S. Pat. Nos. 8,007,278 and 8,202,092.

In one aspect of the present disclosure, an instrument for performing periodontal surgery is provided. The instrument comprises a handle, a blade section, and a connector comprising a first end coupled to the handle and a second end coupled to the blade section. The handle and the first end of the connector form a first angle, and the second end of the connector and the blade section form a second angle. The blade section comprises at least one cutting edge, the connector and the handle lay in and extend along a first plane at the first angle in the first plane relative to one another, and the connector and the blade section lay in and extend along a second plane at the second angle in the second plane relative to one another. The first plane intersects the second plane, and the at least one cutting edge has a cut direction that is substantially orthogonal to the second plane.

In another aspect of the present disclosure, an instrument for performing periodontal surgery is provided. The instrument comprises a longitudinally extending handle, a blade section comprising at least one cutting edge, and a connector comprising a first end coupled to the handle and a second end coupled to the blade section. The connector spaces the blade section laterally from the handle, relative to a longitudinal extent of the handle. The blade section is inclined toward the handle, and the at least one cutting edge defines a cutting plane that is substantially parallel to the longitudinal extent of the handle.

In yet another aspect of the present disclosure, an instrument for performing periodontal surgery is provided. The instrument comprises a longitudinally extending handle, a blade section comprising at least one cutting edge, a connector comprising a first end coupled to the handle and a second end coupled to the blade section. The connector spaces the blade section laterally from the handle, relative to a longitudinal extent of the handle, and the at least one cutting edge defines a cutting plane that is substantially parallel to the longitudinal extent of the handle.

The instruments provide a three-dimensional structure that facilitates periodontal surgery.

In another aspect of the present disclosure, a method of performing periodontal surgery using the instrument described above is described. The method comprises inserting the blade section through an incision in the gingivae with the cutting plane being substantially parallel to a dental plane at the incision. The method further comprises, substantially without rotation of the handle along its longitudinal axis, pivoting the handle substantially about a connector axis defined by the connector to detach a gingival flap, stretching the gingival flap to cover a gingival defect, and securing the gingival flap.

In yet another aspect of the present disclosure, a method of performing periodontal surgery using the above-described instrument is provided. The method comprises inserting the blade section through an incision in the gingivae with the cutting direction being substantially parallel to a dental plane at the incision. The method also comprises, substantially without rotation of the handle along its longitudinal axis, pivoting the handle substantially about a connector axis defined by the connector to detach a gingival flap, stretching the gingival flap to cover a gingival defect, and securing the gingival flap.

Finally, in another aspect of the present disclosure, a method of performing periodontal surgery using the instrument disclosed above is provided. The method comprises inserting the blade section through an incision in the gingivae with the cutting plane being substantially parallel to a dental plane at the incision, substantially without rotation of the handle along its longitudinal axis, pivoting the handle substantially about a connector axis defined by the connector to detach a gingival flap, stretching the gingival flap to cover a gingival defect, and securing the gingival flap.

### BRIEF DESCRIPTION OF THE DRAWINGS

These and other features will become more apparent from the following description in which reference is made to the appended drawings wherein:

FIG. 1A shows a front perspective view of a first illustrative instrument for performing periodontal surgery;

FIG. 1B shows an enlarged view of a portion of FIG. 1A;

FIG. 2A shows a rear perspective view of the instrument of FIG. 1A;

FIG. 2B shows an enlarged view of a portion of FIG. 2A;

FIG. 3 shows a first side elevation view of a blade portion of the instrument of FIG. 1A;

FIG. 4 shows a first end elevation view of the blade portion of the instrument of FIG. 1A;

FIG. 5 shows a second side elevation view of the blade portion of the instrument of FIG. 1A;

FIG. 6 shows second end elevation view of the blade portion of the instrument of FIG. 1A;

FIG. 7 shows a top plan view of the blade portion of the instrument of FIG. 1A;

FIG. 8 shows a bottom plan view of the blade portion of the instrument of FIG. 1A;

FIG. 9A shows a front perspective view of a second illustrative instrument for performing periodontal surgery;

FIG. 9B shows an enlarged view of a portion of FIG. 9A;

FIG. 10A shows a rear perspective view of the instrument of FIG. 9A;

FIG. 10B shows an enlarged view of a portion of FIG. 10A;

FIG. 11 shows a first side elevation view of a blade portion of the instrument of FIG. 9A;

FIG. 12 shows a first end elevation view of the blade portion of the instrument of FIG. 9A;

FIG. 13 shows a second side elevation view of the blade portion of the instrument of FIG. 9A;

FIG. 14 shows second end elevation view of the blade portion of the instrument of FIG. 9A;

FIG. 15 shows a top plan view of the blade portion of the instrument of FIG. 9A;

FIG. 16 shows a bottom plan view of the blade portion of the instrument of FIG. 9A;

FIG. 17A shows a front perspective view of a third illustrative instrument for performing periodontal surgery;

FIG. 17B shows an enlarged view of a portion of FIG. 17A;

FIG. 18A shows a rear perspective view of the instrument of FIG. 17A;

FIG. 18B shows an enlarged view of a portion of FIG. 18A;

FIG. 19 shows a first side elevation view of a blade portion of the instrument of FIG. 17A;

FIG. 20 shows a first end elevation view of the blade portion of the instrument of FIG. 17A;

FIG. 21 shows a second side elevation view of the blade portion of the instrument of FIG. 17A;

FIG. 22 shows second end elevation view of the blade portion of the instrument of FIG. 17A;

FIG. 23 shows a top plan view of the blade portion of the instrument of FIG. 17A;

FIG. 24 shows a bottom plan view of the blade portion of the instrument of FIG. 17A;

FIG. 25A shows a front perspective view of a fourth illustrative instrument for performing periodontal surgery;

FIG. 25B shows an enlarged view of a portion of FIG. 25A;

FIG. 26A shows a rear perspective view of the instrument of FIG. 25A;

FIG. 26B shows an enlarged view of a portion of FIG. 26A;

FIG. 27 shows a first side elevation view of a blade portion of the instrument of FIG. 25A;

FIG. 28 shows a first end elevation view of the blade portion of the instrument of FIG. 25A;

FIG. 29 shows a second side elevation view of the blade portion of the instrument of FIG. 25A;

FIG. 30 shows second end elevation view of the blade portion of the instrument of FIG. 25A;

FIG. 31 shows a top plan view of the blade portion of the instrument of FIG. 25A;

FIG. 32 shows a bottom plan view of the blade portion of the instrument of FIG. 25A;

FIGS. 33 and 34 show an illustrative method for performing periodontal surgery using the instrument of FIG. 1A;

FIG. 35A shows a front perspective view of a first illustrative instrument for performing periodontal surgery;

FIG. 35B shows an enlarged view of a portion of FIG. 35A;

FIG. 36A shows a rear perspective view of the instrument of FIG. 35A;

FIG. 36B shows an enlarged view of a portion of FIG. 36A;

FIG. 37 shows a first side elevation view of a blade portion of the instrument of FIG. 35A;

FIG. 38 shows a first end elevation view of the blade portion of the instrument of FIG. 35A;

FIG. 39 shows a second side elevation view of the blade portion of the instrument of FIG. 35A;

FIG. 40 shows second end elevation view of the blade portion of the instrument of FIG. 35A;

FIG. 41 shows a top plan view of the blade portion of the instrument of FIG. 35A;

FIG. 42 shows a bottom plan view of the blade portion of the instrument of FIG. 35A;

FIG. 43A shows a front perspective view of a second illustrative instrument for performing periodontal surgery;

FIG. 43B shows an enlarged view of a portion of FIG. 43A;

FIG. 44A shows a rear perspective view of the instrument of FIG. 43A;

FIG. 44B shows an enlarged view of a portion of FIG. 44A;

FIG. 45 shows a first side elevation view of a blade portion of the instrument of FIG. 43A;

FIG. 46 shows a first end elevation view of the blade portion of the instrument of FIG. 43A;

FIG. 47 shows a second side elevation view of the blade portion of the instrument of FIG. 43A;

FIG. 48 shows second end elevation view of the blade portion of the instrument of FIG. 43A;

FIG. 49 shows a top plan view of the blade portion of the instrument of FIG. 43A; and

FIG. 50 shows a bottom plan view of the blade portion of the instrument of FIG. 43A.

### DETAILED DESCRIPTION

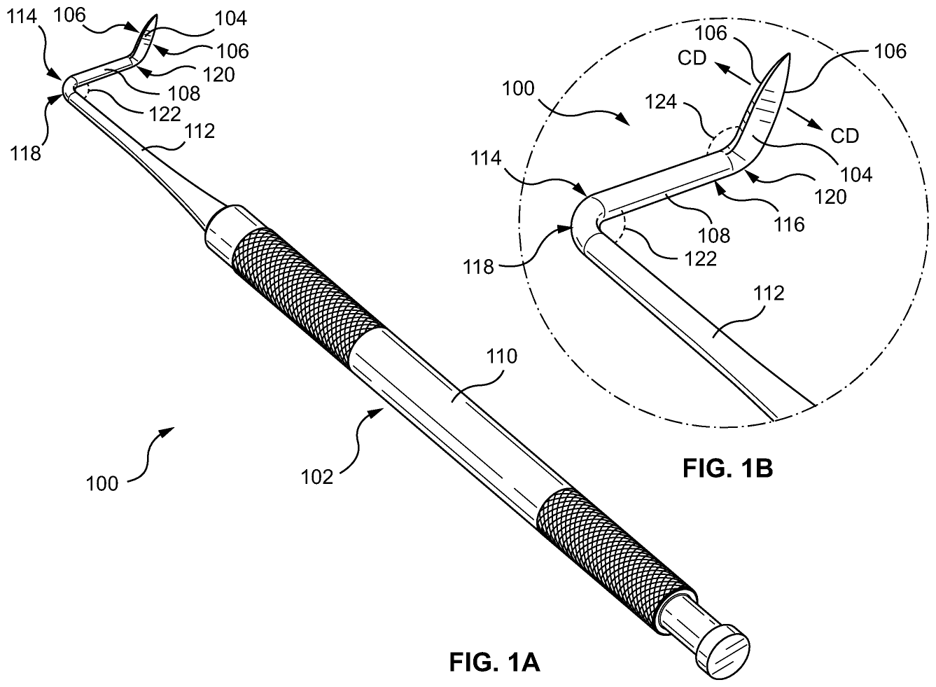

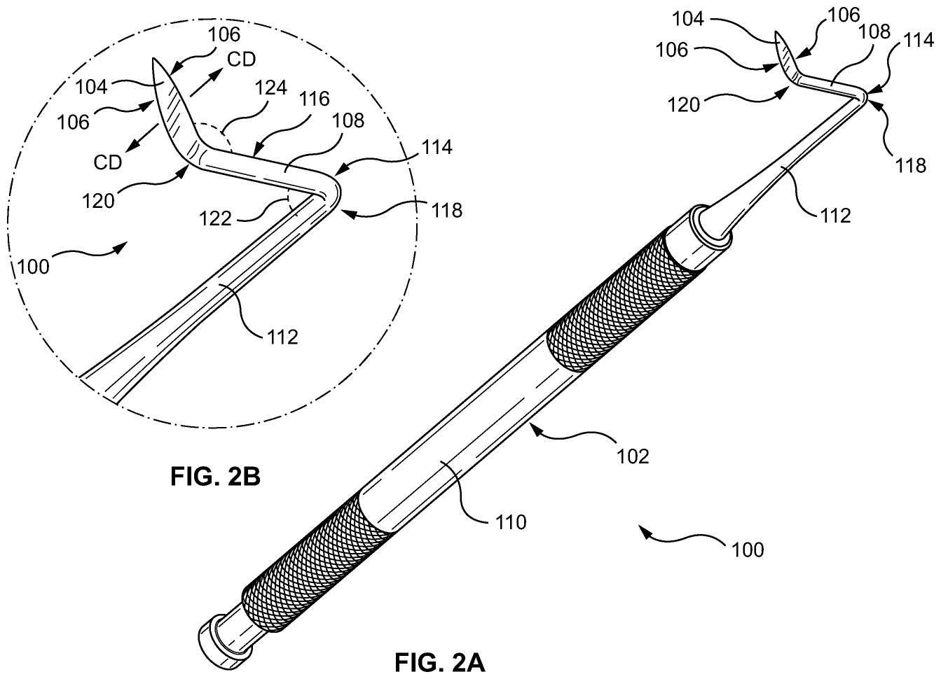

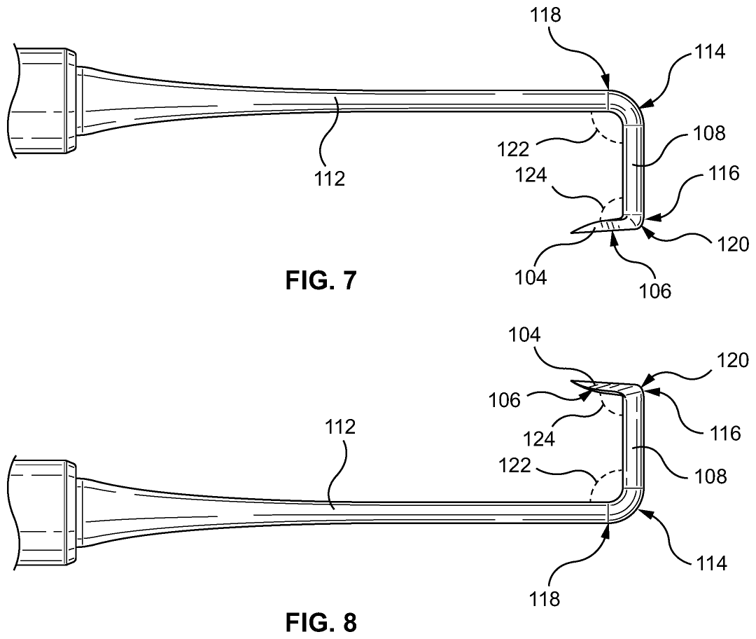

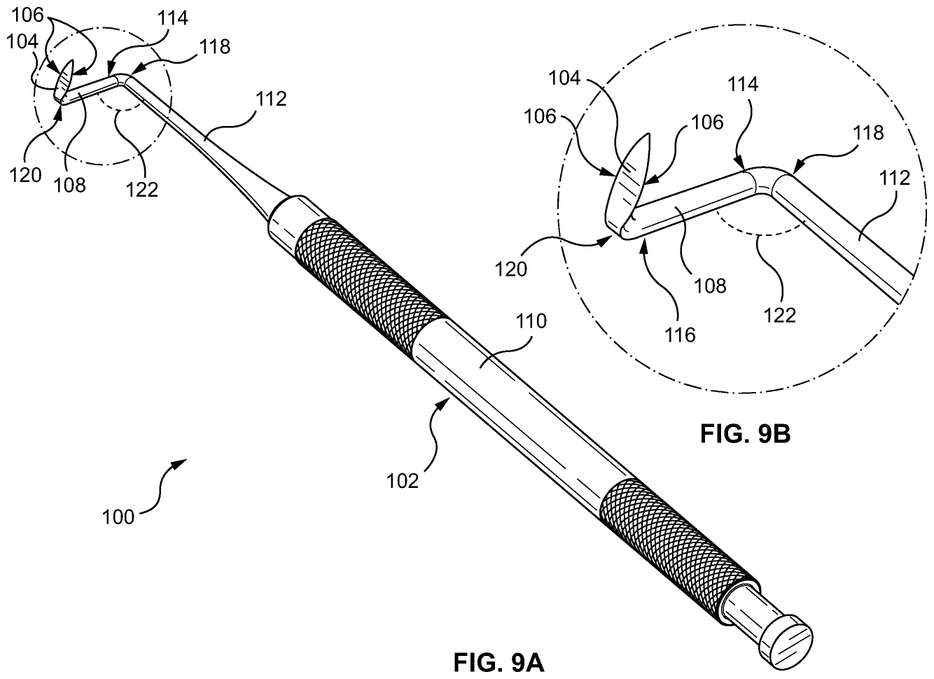

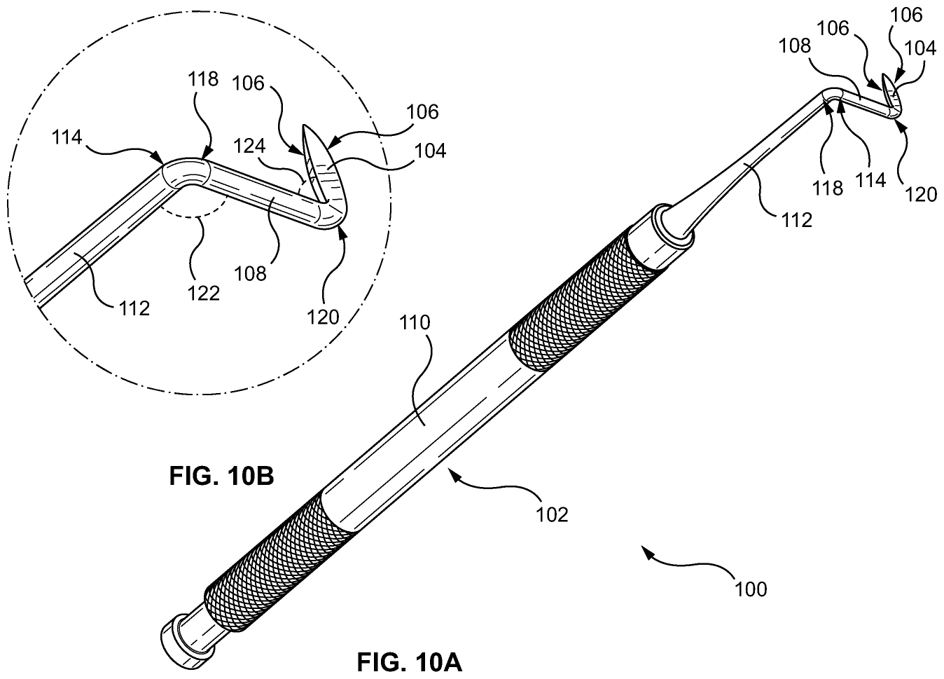

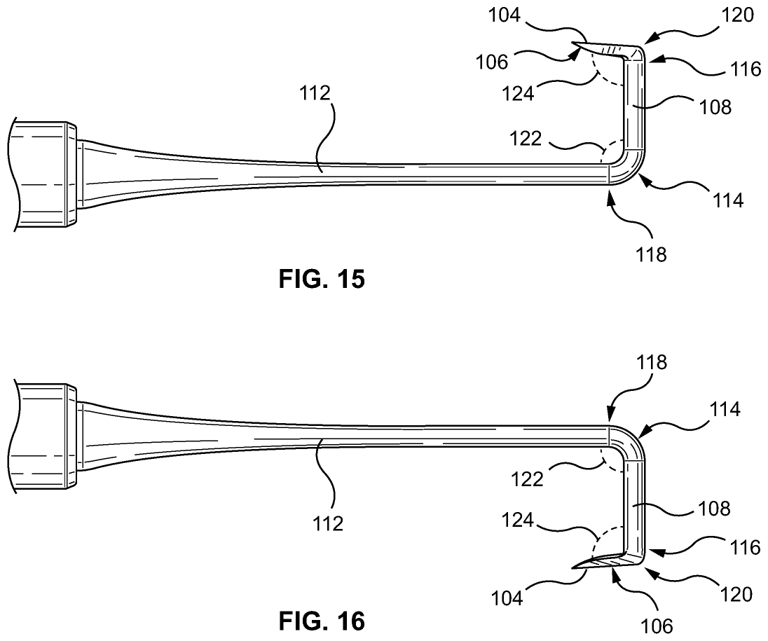

Reference is now made to FIGS. 1A to 8 and 9A to 16, which show, respectively, first and second illustrative embodiments of an instrument for performing periodontal surgery, indicated generally by reference 100. FIGS. 1A to 8 show a right side embodiment of the instrument, and FIGS. 9A to 16 show a left side embodiment. The left side embodiment and the right side embodiment are mirror images of one another.

The instrument 100 comprises a longitudinally extending handle 102 and a blade section 104. The blade section 104 shown in FIG. 1 comprises at least one cutting edge. In the illustrated embodiment shown in FIGS. 1A to 8 and 9A to 16 the blade section is of an Orban knife design with two opposed cutting edges 106, and the cutting edges 106 are curved such that the blade section has a generally navicular or gladiate shape. In other embodiments, the blade section may have only a single cutting edge, or may have a straight cutting edge or edges, or may have one straight cutting edge and one curved cutting edge. Where the blade section has only a single cutting edge, it is preferable that the single cutting edge faces toward the handle.

The instrument 100 further comprises a connector 108 extending between the handle 102 and the blade section 104. In the illustrated embodiment, the handle 102 comprises a main shaft 110 and a tapering neck 112 that extends between the main shaft 110 and the connector 108, substantially parallel to the main shaft 110. In this specification, where angles or other geometric relationships in relation to the handle are specified, these are measured relative to the longitudinal extent of the handle, as defined by the main shaft thereof.

The connector 108 has a first end 114 coupled to the handle 102, in particular the distal end 118 of the neck 112, and a second end 116 coupled to a proximal end 120 of the blade section 104. The connector 108 spaces the blade section 104 laterally from the handle 102, relative to a longitudinal extent of the handle 102. Preferably, the instrument 100, or at least the neck 112, connector 108 and blade section 104, are of unitary, monolithic construction.

The handle 102 and the first end 114 of the connector 108 form a first angle 122 and the second end 116 of the connector 108 and the blade section 104 form a second angle 124. The connector 108 and the handle 102 lay in and extend along a first plane at the first angle 122 in the first plane relative to one another, and the connector 108 and the blade section 104 lay in and extend along a second plane at the second angle 124 in the second plane relative to one another. The first plane intersects the second plane, and the cutting edges 106 each have a cut direction, denoted by arrows CD, that is substantially orthogonal to the second plane.

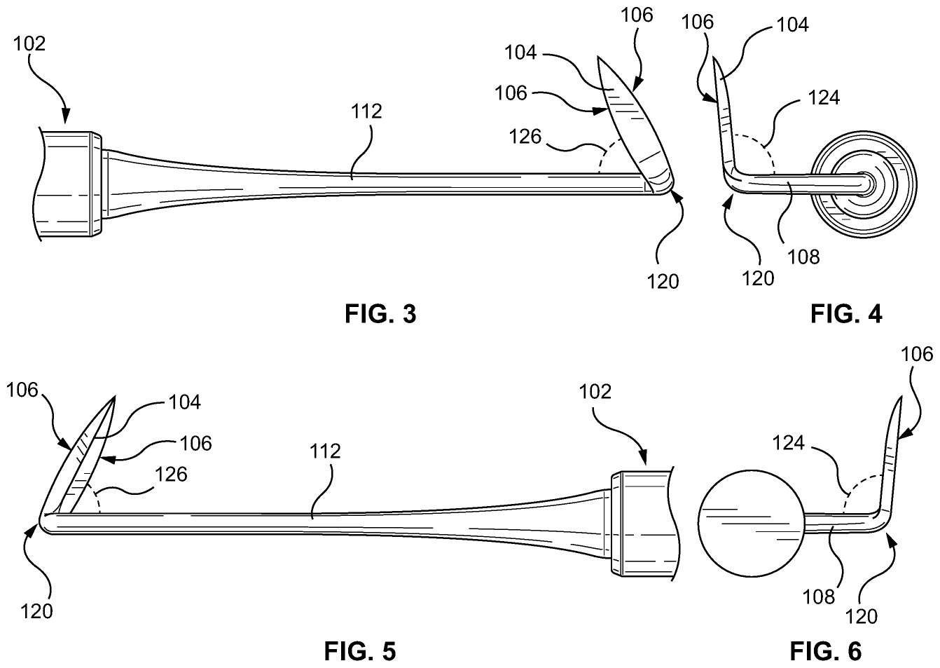

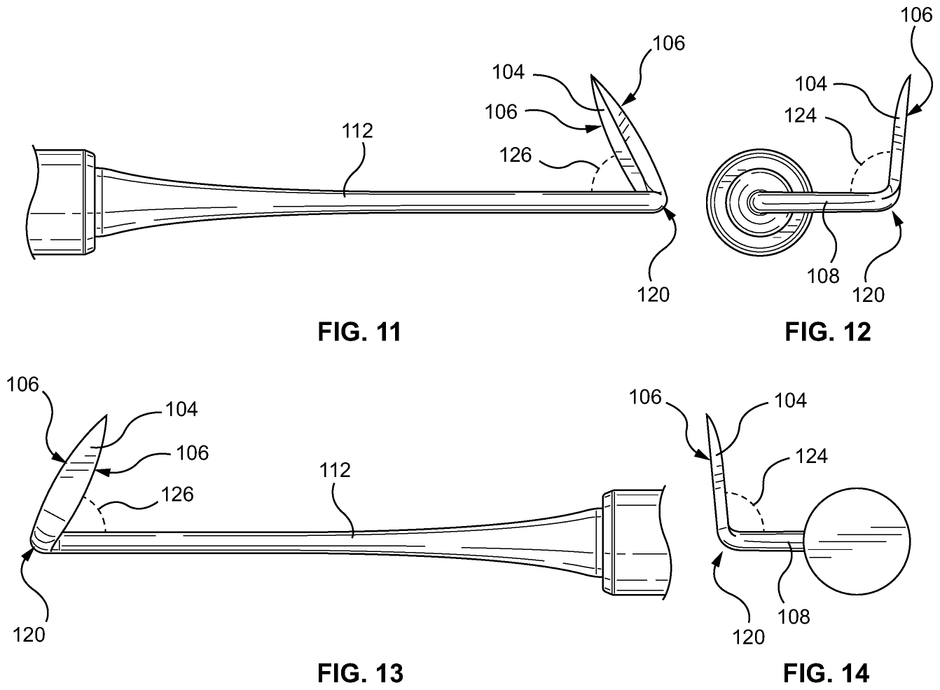

As can best be seen in FIGS. 3 and 5 and in FIGS. 11 and 13, the blade section 104 is inclined toward the handle 102 in the cutting plane, and projects from the connector 108 at a third angle 126 relative to the longitudinal extent of the handle 102, and the cutting edges 106 define a cutting plane that is substantially parallel to the longitudinal extent of the handle 102.

Preferably, the first angle 122 between the handle 102 and the connector 108 is between about 80 degrees and about 100 degrees, more preferably between about 85 degrees and about 95 degrees, and most preferably about 90 degrees. Likewise, the second angle 124 between the blade section 104 and the connector 108 is between about 80 degrees and about 100 degrees, more preferably between about 85 degrees and about 95 degrees, and most preferably about 90 degrees. Thus, in one preferred embodiment, the handle 102 (that is, the longitudinal extent of the handle 102) and the connector 108 are substantially orthogonal to one another and the connector 108 and the blade section 104 are substantially orthogonal to one another.

The illustrated instrument provides for movement in three dimensions, defined by the handle 102, the connector 108 and the blade section 104, and by the first angle 122, the second angle 124 and the third angle 126. Without being limited by theory and without promising any particular utility, the connector 108 allows for the handle to be parallel with the cutting plane of the blade section 104, which allows the dentist to hold the instrument horizontally relative to the dental arch and may in turn permit the dentist to have greater comfort, more control and a better perspective on what and where they are operating.

Preferably, the blade section 104 projects from the connector 108 at a third angle 126. The third angle 126 is between about 30 degrees and about 60 degrees, more preferably between 40 degrees and 50 degrees relative to the longitudinal extent of the handle 102, and most preferably at an angle of about 45 degrees relative to the longitudinal extent of the handle 102. Without being limited by theory and without promising any particular utility, it is believed that the preferred third angle 126 may improve the ability of a dentist to enter and exit the gingivae, and to more easily control the area in which they are operating and limit the damage to the gingivae.

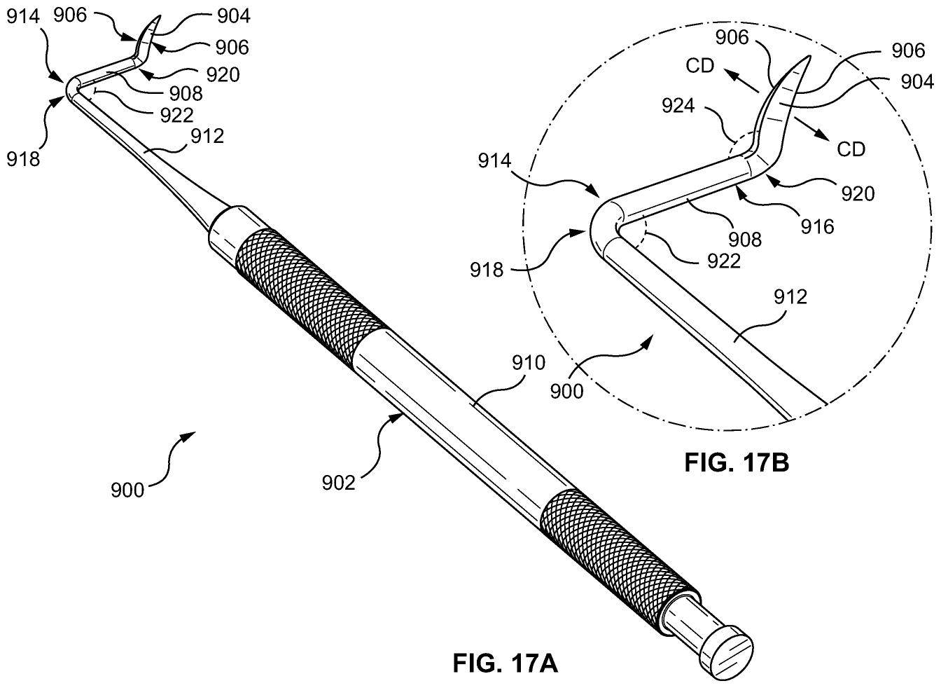

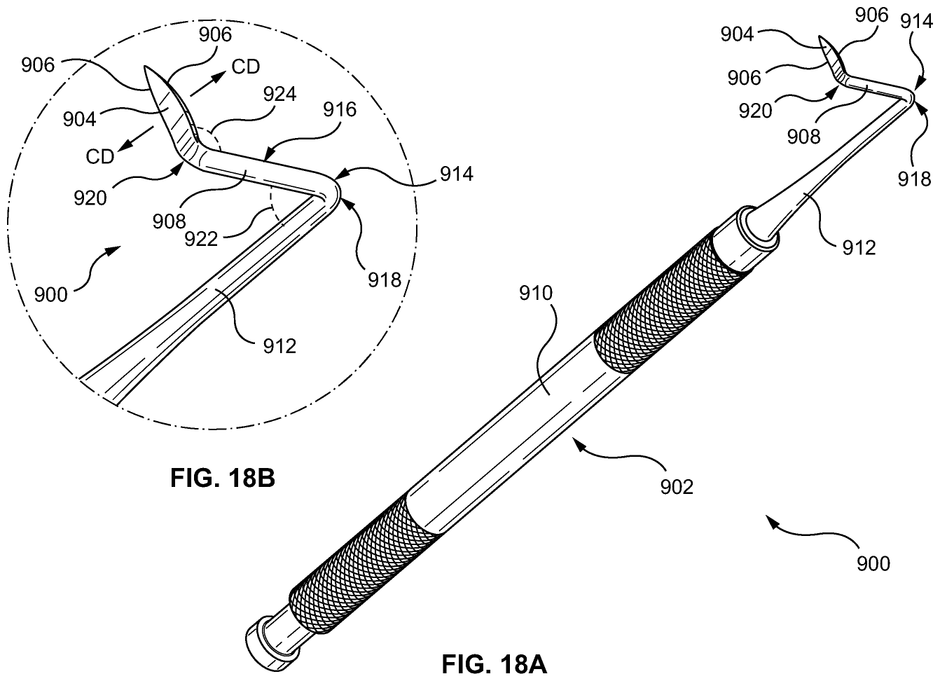

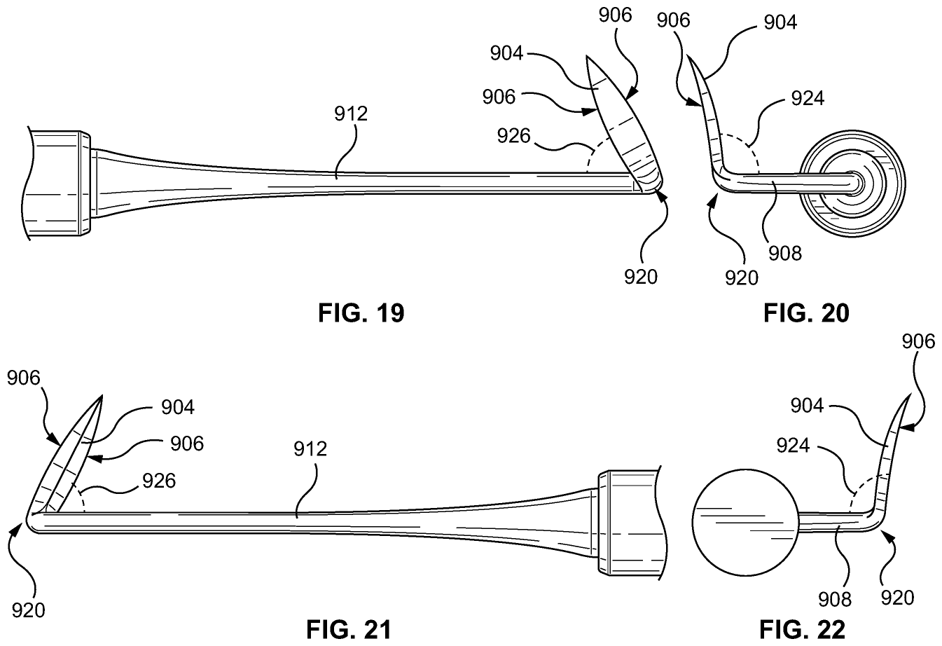

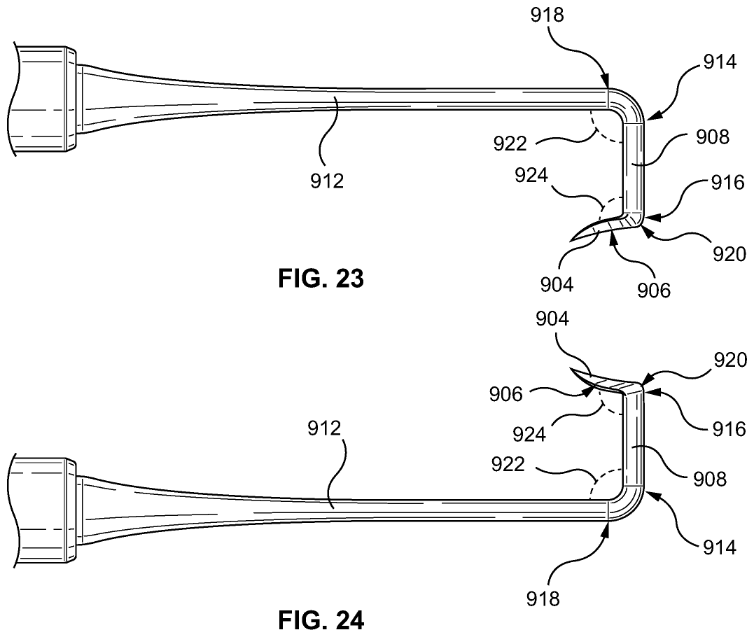

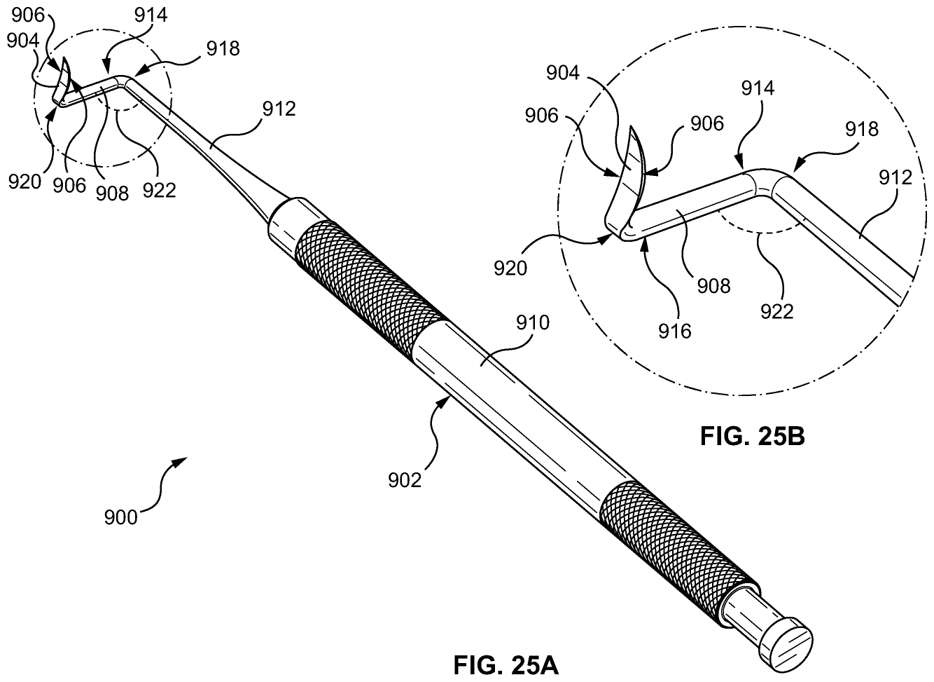

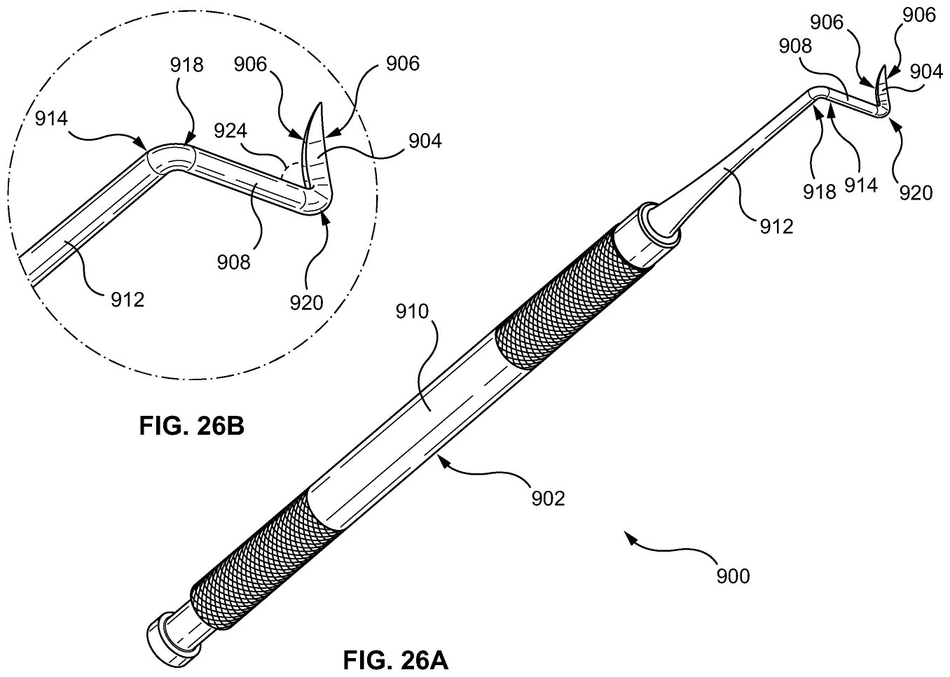

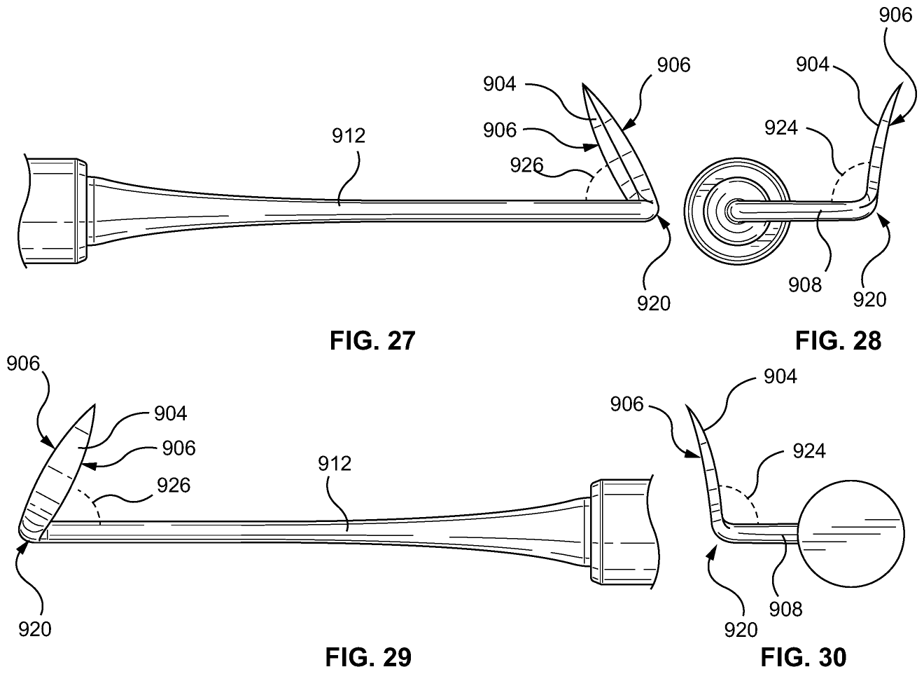

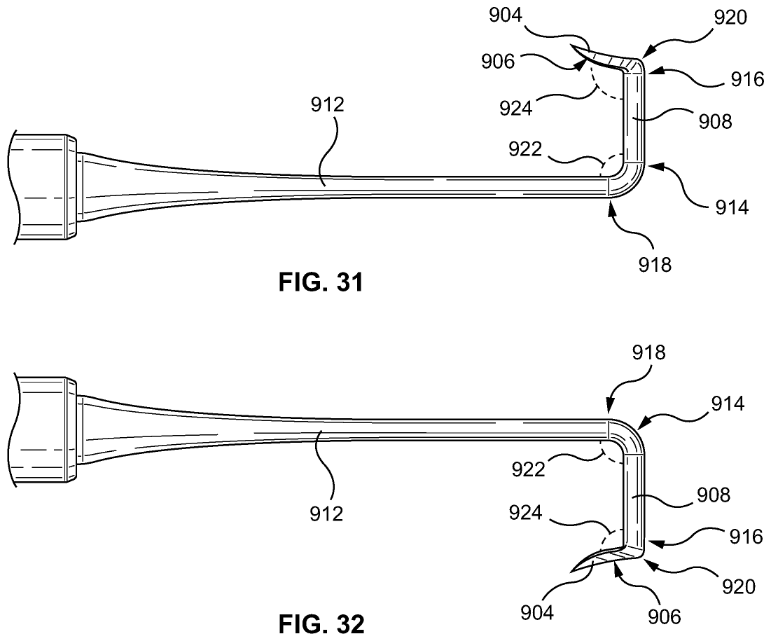

In the illustrated embodiment shown in FIGS. 1A to 8 and 9A to 16, the blade section has a substantially straight, linear projection relative to the handle 102 and connector 108. FIGS. 17A to 24 and 25A to 32 show third and fourth embodiments of the instrument which are, respectively, right side and left side mirror-image embodiments of the instrument, indicated generally by reference 900. In the third and fourth embodiments of the instrument 900, the blade section 904 is outwardly curved relative to the handle 902. The embodiment shown in FIGS. 17A to 24 and 25A to 32 is otherwise similar to that shown in FIGS. 1A to 8 and 9A to 16 and like reference numerals denote like features except with the prefix “9” instead of “1”.

Instruments according to the present disclosure can be used to perform periodontal surgery, for example to loosen gingival tissue, which can then be repositioned over a receded portion of a tooth. Instruments according to the present disclosure provide a three-dimensional structure to facilitate such surgery.

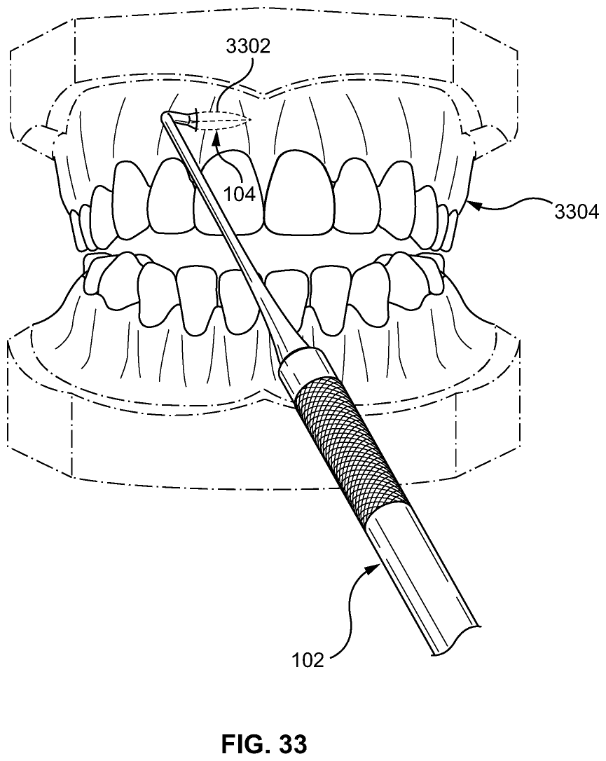

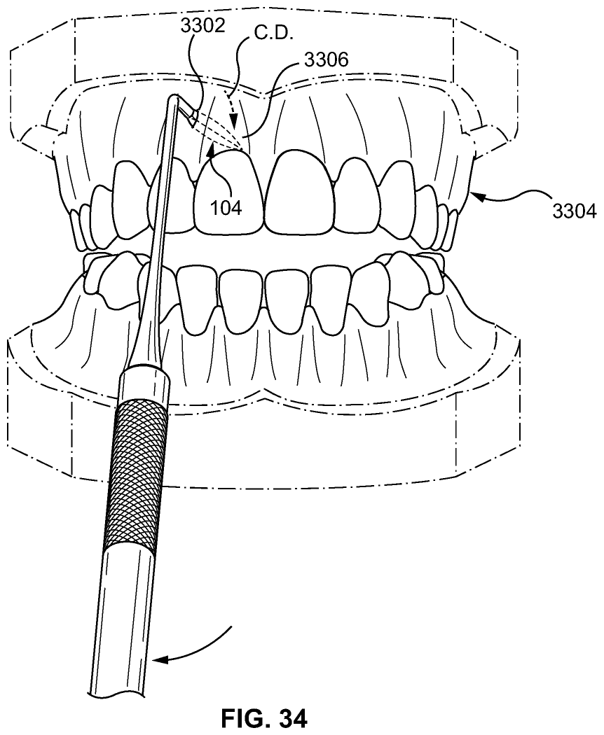

Reference is now made to FIGS. 33 and 34, which illustrate a method of performing periodontal surgery using the instruments described herein, using the embodiment shown in FIGS. 1A to 8 as a non-limiting, illustrative example. As shown in FIG. 33, the method comprises inserting the blade section 104 through an incision 3302 in the gingivae 3304. The incision may be made by the blade section 104 itself, or using another tool, for example a micro blade. As can be seen, the blade section 104 is inserted with the cutting direction CD and the cutting plane being substantially parallel to a dental plane at the incision 3302. The dental plane for a given tooth is a notional plane that is substantially tangential to the dental arch and to the outer face of the tooth.

After the blade section 104 is inserted, the method further comprises pivoting the handle 102 substantially about a connector axis defined by the connector 108 to detach a gingival flap 3306, as shown in FIG. 34. Pivoting the handle 102 causes the blade section 104 to also pivot about the connector axis, so that the cutting edges 106 move through the cutting plane, which is substantially parallel to the dental plane. Critically, the pivoting of the handle 102 is performed substantially without rotation of the handle 102 along its longitudinal axis. During this procedure, it may be helpful to apply pressure to the connector, along the connector axis, for example with the thumb. After the gingival flap 3306 has been detached, the gingival flap 3306 is then stretched to cover a gingival defect, such as a receded portion of a tooth, and then secured, for example using conventional techniques. Notably, the incision 3302 is made toward the apical edge of the gingivae 3304, and the blade section 104 pivots toward the coronal edge of the gingivae 3304. The incision will typically be about 8 mm to 10 mm from the gum line for adult incisor teeth. Whereas in the Pinhole® Surgery Technique method the incision is made about midway between the apical edge of the gingivae and the coronal edge of the gingivae, in the presently described method the incision 3302 is made much closer to the apical edge of the gingivae 3304 and much further from the coronal edge of the gingivae 3304.

The incision will typically be between 1 mm and 5 mm in length. Allowing a dentist to choose the size of the incision provides the dentist with freedom to decide on where to enter and where to operate on the gingivae 3304. For larger incisions, e.g. 3 mm to 5 mm, suturing is usually required. However, the sutured incision 3302 will usually be hidden by the upper lips, removing any obvious indication of surgery to allow for a more aesthetically pleasing result.

Instruments according to the present disclosure can be provided in various sizes, for example to accommodate the differing gingival extent associated with different teeth. In one illustrative implementation, the instruments may be provided in small, medium and large sizes. The table below provides non-limiting illustrative dimensions for the neck 112, 912, the connector 108, 908 and the blade section 104, 904 of the instrument 100, 900 in each of a small, medium and large size:

| | Small | Medium | Large |
|---|---|---|---|
| Neck | 40 mm | 40 mm | 40 mm |
| Connector | 9 mm | 9 mm | 9 mm |
| Blade Section | 9 mm | 13 mm | 16 mm |

While a dentist will of course exercise skill and judgment in selecting an instrument of appropriate size, in some embodiments the “small” size instruments may be used for the gingivae associated with the incisor, canine/cuspid and first molar teeth, the “medium” size instruments may be used for the gingivae associated with the first bicuspid/premolar and second molar teeth and the “large” size instruments may be used for the gingivae associated with the second bicuspid/premolar and third molar (wisdom) teeth. Typically, the right side instruments would be used on the right side of the mouth and the left side instruments would be used on the left side of the mouth, in each case from the patient's perspective.

As noted above, the cutting edges 106 each have a cut direction, denoted by arrows CD, that is substantially orthogonal to the second plane and the cutting edges 106 define a cutting plane that is substantially parallel to the longitudinal extent L of the handle 102.

These features enable the gingival flap 3306 to be detached by pivoting of the handle 102 substantially without rotation of the handle 102 along its longitudinal axis. Without being limited by theory and without any particular promise of utility, the foregoing features enable the handle to be held horizontally relative to the dental arch/dental plane, which may make it easier to hold and manipulate the handle and may provide for balance and controlled momentum during detachment of the gingival flap.

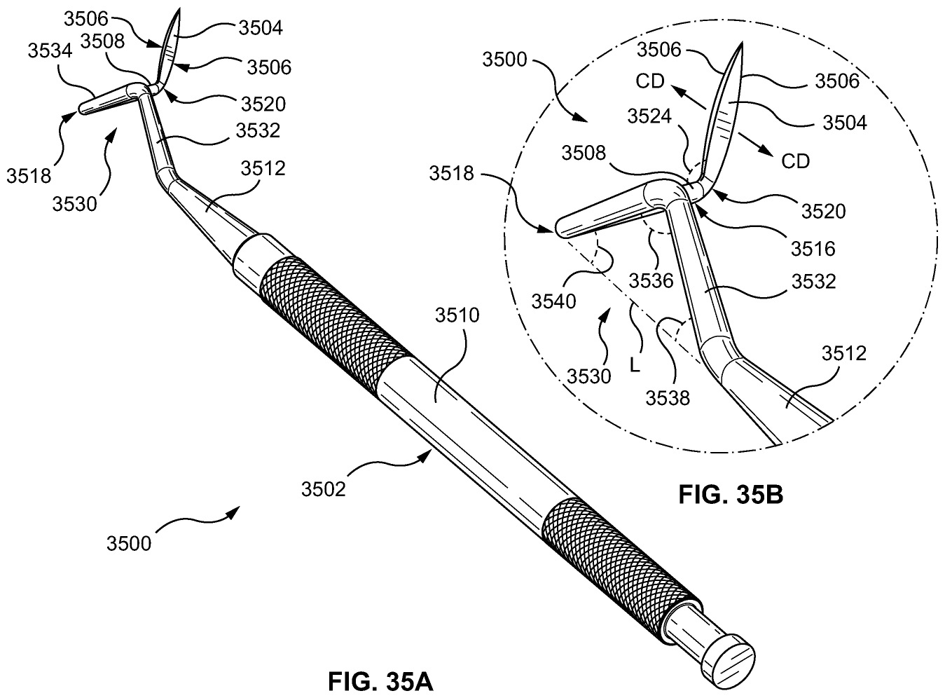

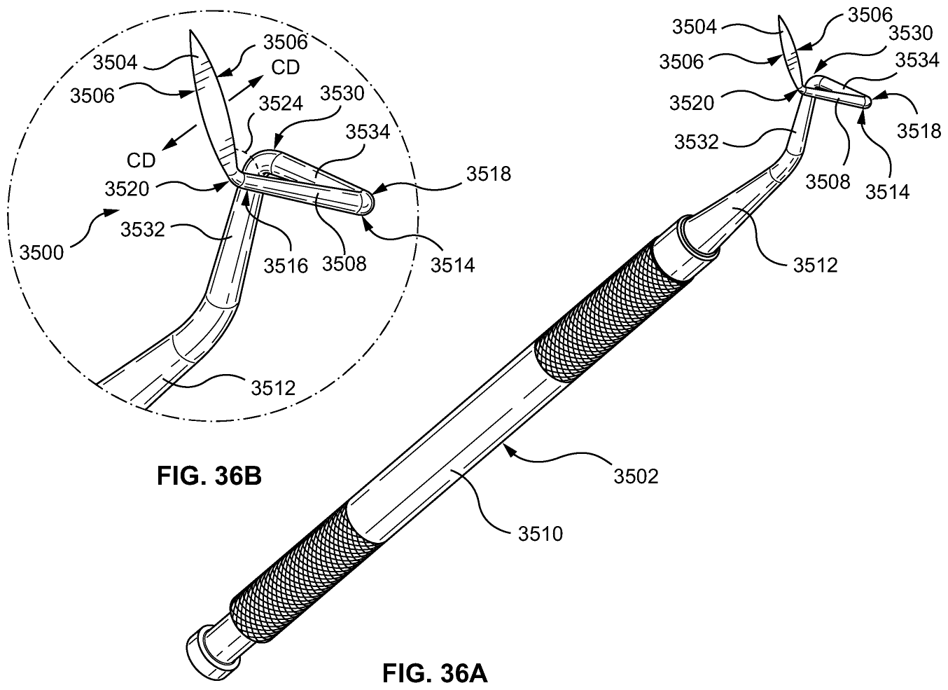

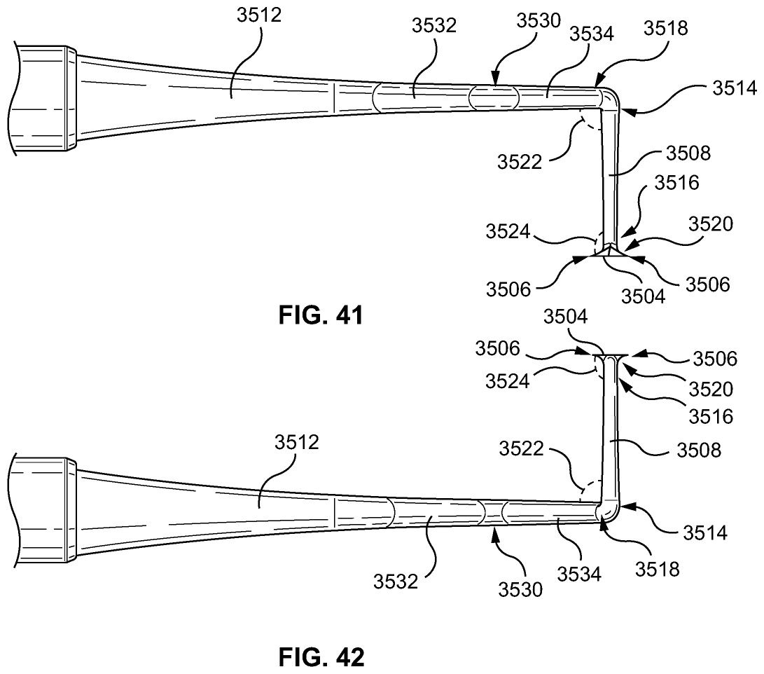

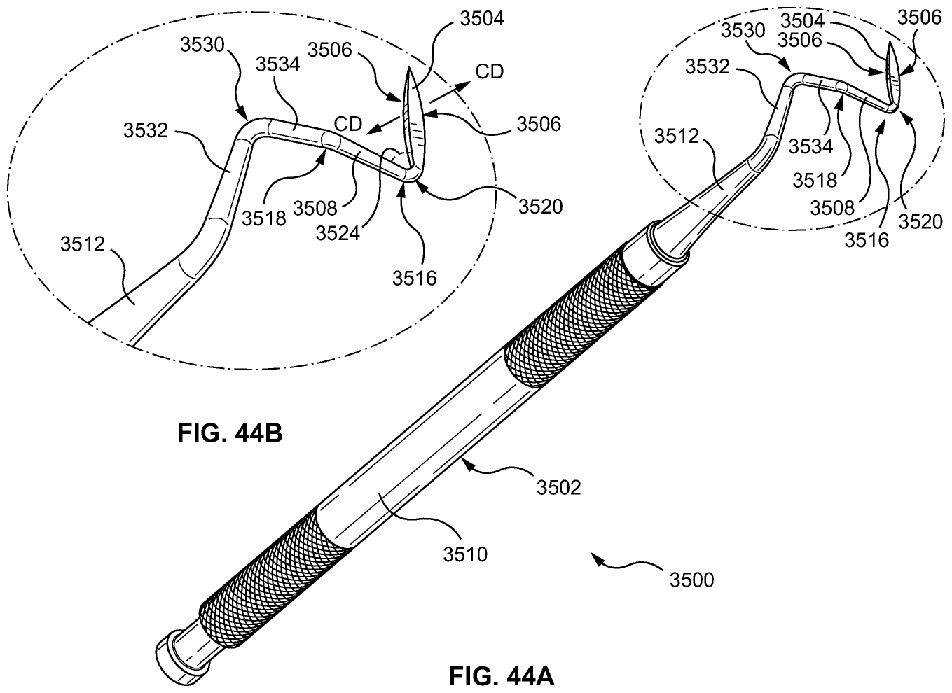

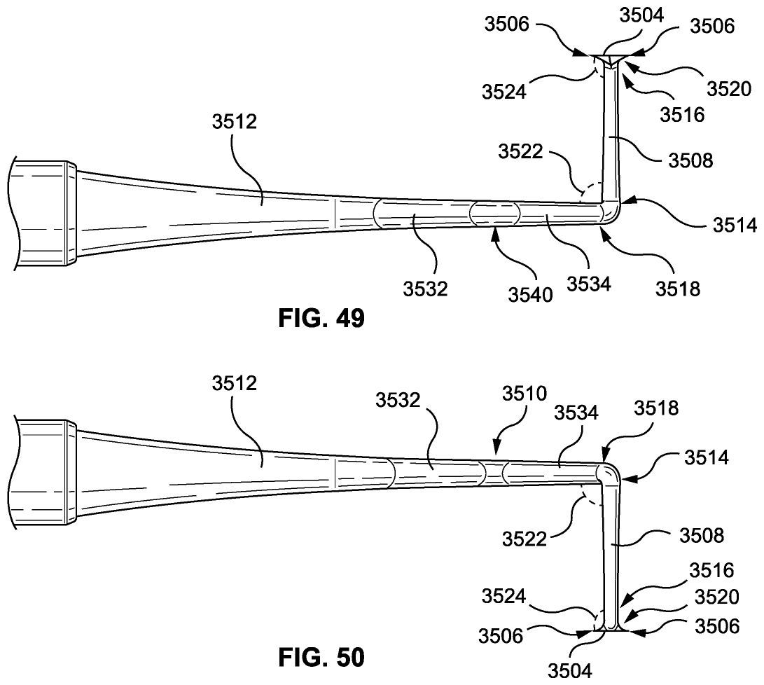

Reference is now made to FIGS. 35A to 42 and 43A to 50 which show, respectively, fifth and sixth embodiments of the instrument, which are respectively right side and left side mirror-image embodiments, indicated generally by reference 3500. These are similar to the first and second embodiment 100, with like reference numerals denoting like features except with the prefix “35” instead of “1”. The fifth and sixth embodiments 3500 differ from the first and second embodiments 3500 in that the neck 3512 of the fifth and sixth embodiments 3500 include an elbow 3530 and in the angle 3526 at which the blade section 3504 projects from the connector 3508.

The elbow 3530 deviates from the longitudinal extent L of the handle 3502 and comprises a proximal member 3532 and a distal member 3534, with the distal end 3518 of the distal member 3534 of the elbow 3530 being the distal end of the neck 3512. The first end 3514 of the connector 3508 is coupled to the handle 3502, in particular the distal end 3518 of the distal member 3534 (which is also the distal end 3514 of the neck 3512, and the second end 3516 of the connector 3508 is coupled to the proximal end 3520 of the blade section 3504. Without being limited by theory and without promising any particular utility, it is believed that the elbow 3530 may improve the ability of a dentist to enter and exit the gingivae, and to more easily control the area in which they are operating and limit the damage to the gingivae.

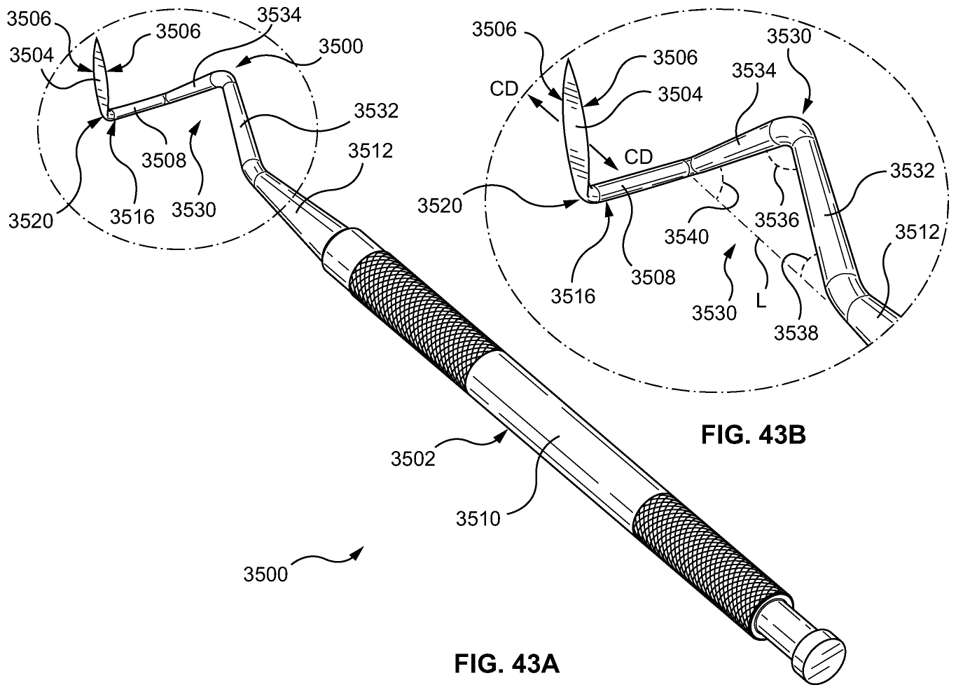

The connector 3508 spaces the blade section 3504 laterally from the handle 3502, relative to a longitudinal extent L (FIGS. 35B, 43B) of the handle 3502. As shown in FIGS. 35B and 43B, the proximal member 3532 and the distal member 3534 are approximately orthogonal with one another (the angle 3536 is approximately 90 degrees) and form respective angles 3538, 3540 of about 45 degrees with the longitudinal extent L of the handle 3502. Thus, as with the first embodiment 100, in the third embodiment 3500 the handle 3502 and the first end 3514 of the connector 3508 form a first angle 3522. As indicated above, the angle 3522 is measured between the first end 3514 of the connector 3508 and the longitudinal extent L of the handle 3502 as defined by the main shaft 3510, ignoring the bends of the elbow 3530. The second end 3516 of the connector 3508 and the blade section 3504 form a second angle 3524. The connector 3508 and the handle 3502 (that is, the longitudinal extent thereof, ignoring the elbow bends) lay in and extend along a first plane at the first angle 3522 in the first plane relative to one another, and the connector 3508 and the blade section 3504 lay in and extend along a second plane at the second angle 3524 in the second plane relative to one another. The first plane intersects the second plane, and the cutting edges 3506 each have a cut direction, denoted by arrows CD, that is substantially orthogonal to the second plane.

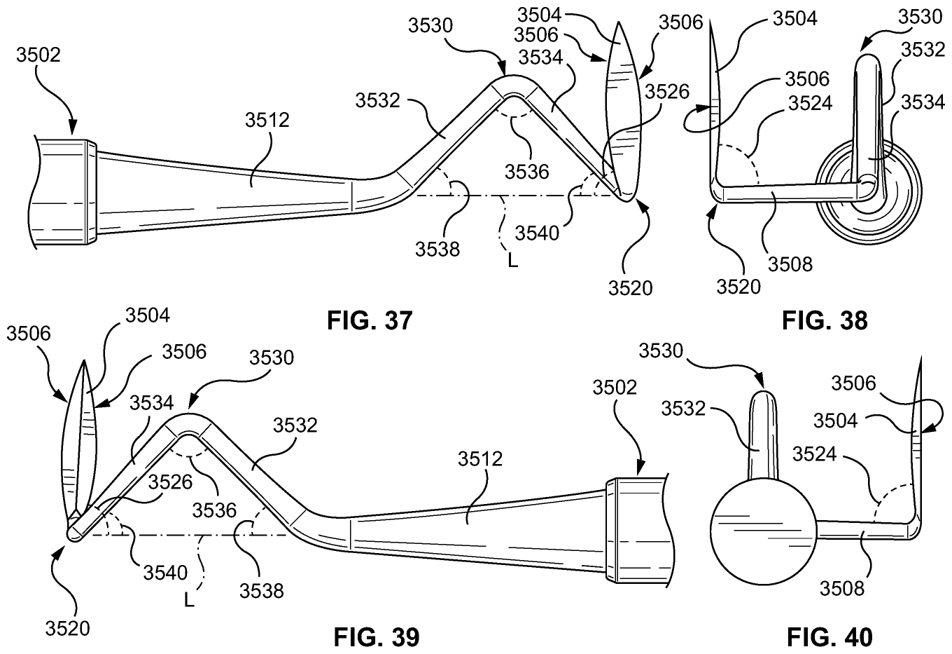

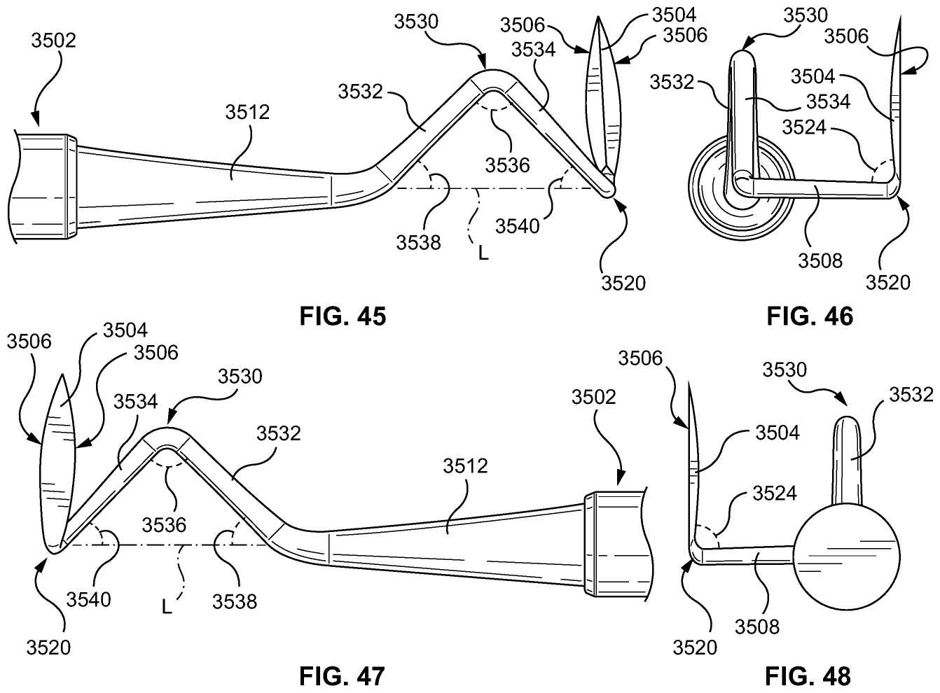

As can best be seen in FIGS. 37 and 39 and in FIGS. 45 and 47, the blade section 3504 is inclined toward the handle 3502 in the cutting plane, and projects from the connector 3508 at a third angle 3526 relative to the longitudinal extent of the handle 3502, and the cutting edges 3506 define a cutting plane that is substantially parallel to the longitudinal extent L of the handle 3502.

Preferably, the first angle 3522 between the handle 3502 (defined by its longitudinal extent L) and the connector 3508 is between about 80 degrees and about 100 degrees, more preferably between about 85 degrees and about 95 degrees, and most preferably about 90 degrees. Likewise, the second angle 3524 between the blade section 3504 and the connector 3508 is between about 80 degrees and about 100 degrees, more preferably between about 85 degrees and about 95 degrees, and most preferably about 90 degrees. Thus, in one preferred embodiment, the handle 3502 and the connector 3508 are substantially orthogonal to one another and the connector 3508 and the blade section 3504 are substantially orthogonal to one another.

The blade section 3504 projects from the connector 3508 at a third angle 3526, which is significantly less than in the first embodiment 100. In the third embodiment 3500, the third angle 3526 is between about 70 degrees and about 110 degrees, more preferably between 80 degrees and 100 degrees relative to the longitudinal extent L of the handle 3502, and most preferably at an angle of about 90 degrees (approximately orthogonal) relative to the longitudinal extent L of the handle 3502.

The handles 102, 902, 3502, including respective main shafts 110, 910, 3510 and necks 112, 912, 3512, the connectors 108, 908, 3508 and the blade sections 104, 904, 3504 shown in the drawings are merely illustrative and not limiting. The handle, main shaft, neck, connector, and blade section of an instrument according to the present disclosure are not limited to the shapes and configurations shown, and may be of any suitable shape and configuration. Certain illustrative embodiments have been described by way of example. It will be apparent to persons skilled in the art that a number of variations and modifications can be made without departing from the scope of the claims.

1. An instrument for performing periodontal surgery comprising:
a handle;
a blade section;
a connector comprising a first end coupled to the handle and a second end coupled to the blade section;
the handle and the first end of the connector forming a first angle; the second end of the connector and the blade section forming a second angle;
wherein the blade section comprises at least one cutting edge;
wherein the connector and the handle lay in and extend along a first plane at the first angle in the first plane relative to one another;
wherein the connector and the blade section lay in and extend along a second plane at the second angle in the second plane relative to one another;
wherein the first plane intersects the second plane; and
wherein the at least one cutting edge has a cut direction that is substantially orthogonal to the second plane.

2. The instrument of claim 1, wherein the blade section has only a single cutting edge.

3. The instrument of claim 2, wherein the single cutting edge faces toward the handle.

4. The instrument of claim 1, wherein the blade section has two opposed cutting edges.

5. The instrument of claim 1, wherein the at least one cutting edge comprises a curved cutting edge.

6. The instrument of claim 1, wherein the at least one cutting edge comprises a straight cutting edge.

7. The instrument of claim 1, wherein the handle comprises a main shaft and a tapering neck that extends between the main shaft and the connector.

8. The instrument of claim 7, wherein the neck includes an elbow deviating from a longitudinal extent of the handle as defined by the main shaft.

9. An instrument for performing periodontal surgery, comprising:
a longitudinally extending handle;
a blade section comprising at least one cutting edge;
a connector comprising a first end coupled to the handle and a second end coupled to the blade section;
the connector spacing the blade section laterally from the handle, relative to a longitudinal extent of the handle;
wherein the blade section is inclined toward the handle; and
wherein the at least one cutting edge defines a cutting plane that is substantially parallel to the longitudinal extent of the handle.

10. The instrument of claim 9, wherein the blade section projects from the connector at an angle of between about 30 degrees and about 60 degrees relative to the longitudinal extent of the handle.

11. The instrument of claim 9, wherein the blade section projects from the connector at an angle of between 40 degrees and 50 degrees relative to the longitudinal extent of the handle.

12. The instrument of claim 9, wherein the blade section projects from the connector at an angle of about 45 degrees relative to the longitudinal extent of the handle.

13. The instrument of claim 9, wherein the blade section has only a single cutting edge.

14. The instrument of claim 13, wherein the single cutting edge faces toward the handle.

15. The instrument of claim 9, wherein the blade section has two opposed cutting edges.

16. The instrument of claim 9, wherein the at least one cutting edge comprises a curved cutting edge.

17. The instrument of claim 9, wherein the at least one cutting edge comprises a straight cutting edge.

18. The instrument of claim 9, wherein the handle comprises a main shaft and a tapering neck that extends between the main shaft and the connector.

19. The instrument of claim 18, wherein the neck includes an elbow deviating from the longitudinal extent of the handle.

20-35. (canceled)
